(19) United States
(12) Patent Application Publication
(10) Pub. No.: US 2007/0098594 A1
(43) Pub. Date: May 3, 2007

(54) Analytical multi-spectral optical detection system

(75) Inventors: Christopher J. Elkin, San Ramon, CA (US); William M. Hoover, Patterson, CA (US); Ronald T. Kurnik, Foster City, CA (US)

Correspondence Address: TOWNSEND AND TOWNSEND AND CREW, LLP, 2 EMBARCADERO CENTER, 8TH FLOOR, SAN FRANCISCO, CA, 94111, US

(73) Assignee: Roche Molecular Systems, Inc., Alameda, CA (US)

(21) Appl. No.: 11/267,962

(22) Filed: Nov. 3, 2005

(51) Int. Cl. G01N 35/00

(52) U.S. Cl. 422/64

(57) ABSTRACT

Analytical multi-spectral optical detection systems and methods. A light source provides one or multiple lines (e.g., discrete wavelengths) of high spectral purity excitation light that is optically coupled to a sample via delivery fiber optic cables. Emission light is collected and provided to an emission detector, such as a diffraction gradient spectrophotometer emission detector, using collection fiber optic cables bundled with the delivery fiber optic cables in a probe interface positioned proximal a sample holder. The probe interface may be scanned over one or more samples, or one or more samples may be scanned proximal a fixed interface probe. Multiple excitation wavelengths allows for simultaneous excitation and detection of multiple fluorescent dyes in the visible spectrum. This increases sample throughput and reduces signal variations associated with signal acquisition at different times. The optical system provides several advantages over other systems including higher sensitivity, improved compatibility with fluorescent dyes, better signal discrimination, increased system reliability and reduced manufacturing and service costs.

### BACKGROUND OF THE INVENTION

The present invention relates generally to signal detection and analysis, and more particularly to multi-spectral fluorescent signal detection and analysis.

Many systems exist today for exciting and detecting fluorescent signals in solid or liquid samples. Examples of such systems can be found in U.S. Pat. No. 6,015,674, U.S. Pat. No. 5,928,907 U.S. Pat. No. 6,713,297, US20020109844 A1, EP1080364 B1, and EP1080364 A1.

Each of these systems has drawbacks. For example, the use of a plurality of fiber optic cables in U.S. Pat. No. 6,015,674A and U.S. Pat. No. 5,928,907A, and independent optics for each sample in U.S. Pat. No. 6,713,297 B2, US20020109844 A1, EP1080364 B1, and EP1080364 A1 increase the number of optical system components. Many commercial systems also use filters to control the light bandwidth which further increases the number optical components. This results in reduced detection precision combined with higher manufacturing and service costs.

Another limitation of filter-based optical systems is their inability to detect all of the fluorescent dyes commonly used in e.g., medical diagnostic assays. Each dye requires one or more specific bandwidth filters for detection because the excitation spectra of the dyes overlap and the emission spectra of the dyes overlap. Specific combinations of filters are required to differentiate a dye from other dyes in a dye mixture when using a filter-based system.

Currently, a filter-based optical system can only resolve seven dyes (or emission spectra) in a dye mixture. The emission spectra overlaps of mixtures containing more than five dyes are difficult to correct for with mathematical algorithms and optical controls. This limits the ability of filter-based optical systems to quantitatively detect the dyes in assays used for medical diagnostics.

Other consequences of filter-based optical systems are that the optical system cannot be easily adapted to correct for assay problems or to accommodate new dyes. For example, if a medical diagnostic test produces false results with a patient sample, no additional information can be obtained from the optical system to compensate for the problem. The light signal bandwidth specifications are fixed.

Fixed bandwidths also increase the costs and time required to upgrade such a system. If new dyes become available, the filters will need to be changed. This would require the entire optical system to be revalidated if the system is used as part of a medical diagnostic instrument. In addition, some filters may not be upgradeable as previous dyes may no longer work with the instrument.

Many of the currently available commercial optics designs place the optical interfaces under or in the sample tube holders. Examples are shown in FIG. 6. During pre-sample processing, compounds such as salt and other chemicals may be deposited on the outside of the tube. This material can build up in the optical interfaces causing partial or complete occlusion of the light path. This can produce incorrect results.

Fluorescent signal precision and accuracy are also susceptible to partial blockage of random wells. Light path transmission efficiencies can be altered thereby reducing the well to well sample result reproducibility. Signal variations also produce more strain on the signal processing algorithm further reducing reliability. Thermal control efficiency and uniformity also suffer due to the holes present in the thermal control block of these other designs.

It is clear that there is a need for improved optical detection systems and methods for measuring fluorescence signals that overcome the above and other problems.

### BRIEF SUMMARY OF THE INVENTION

The present invention provides systems and methods for measuring fluorescence signals. The systems and methods of the present invention provide highly accurate fluorescent based measurements of liquid samples or solid surfaces such as nucleic acid or protein detection arrays. For example, the systems and methods of the present invention are particularly useful in polymerase chain reaction (PCR) systems, especially real-time, quantitative PCR systems used for medical diagnostics.

According to the present invention, an analytical multi-spectral optical detection system includes a light source that provides one or multiple discrete wavelengths of high spectral purity excitation light that is optically coupled to a sample either directly or by fiber optic cables, e.g., using collection fiber optic cables bundled with excitation light delivery fiber optic cables. Emitted light is collected and provided to an emission detector, such as a diffraction gradient spectrophotometer emission detector, which spatially separates the emitted light into component wavelengths. Therefore, a single optical path may be used for all spectral signals from all samples and fluorescent dyes. Advantageously, the hardware components and designs of the present invention minimize the number of hardware components and reduce assembly complexity. The optical system also provides several advantages over other similar systems including higher sensitivity, improved compatibility with fluorescent dyes, better signal discrimination, increased system reliability and reduced manufacturing and service costs.

The optical system describe herein can scan solid surfaces and determine the quantitative amount of unique color emissions from a specified area. The most common example would be a spatially resolved micro-array in which chemistry is performed on the surface of a glass slide or in the well of a micro-titer plate. This optical system provides the same advantages over prior optical systems in that more dyes can be detected with greater accuracy.

In certain aspects, the present invention uses simultaneous excitation and detection of multiple fluorescent dyes in the visible spectrum. This increases sample throughput and reduces signal variations associated with signal acquisition at different times. It also allows for dyes such as direct excitation and/or energy transfer dyes to be detected making the optical system more compatible with future assays.

According to one aspect of the present invention, an apparatus for detection of induced light emission in a sample is provided. The apparatus typically includes a sample container, and a light source configured to provide excitation light to the sample container, where the excitation light includes a plurality of different discrete wavelengths of light. The apparatus also typically includes an emission detector configured to receive and spatially separate light emanating from the sample container into component wavelengths. In certain aspects, the light source includes a first fiber optic cable positioned to deliver the excitation light to the sample container. In certain aspects, the apparatus includes a second fiber optic cable positioned to receive the light emanating from the sample container and deliver it to the emission detector. In one aspect, the second fiber optic cable or emission detector includes one or more filters that remove scattered excitation light. In certain aspects, the light source includes a single or a plurality of laser diodes, each laser diode generating one or multiple discrete wavelengths.

According to another aspect of the present invention, a system for detection of induced light emission in a sample is provided. The system typically includes a sample container, an emission detector, and an excitation source configured to generate excitation light having a plurality of different discrete wavelengths. The emission detector is configured to spatially separate received light into component wavelengths. The system also typically includes a first fiber optic cable having a first input end and a first output end, wherein the first input end is positioned to receive the excitation light from the excitation source, a second fiber optic cable having a second input end and a second output end, wherein the second output end is positioned to provide emission light received from the sample container to the emission detector, and a cable interface configured to hold the first output end and the second input end together proximal to the sample container. In operation, the first output end provides the excitation light to the sample container and the second input end receives the light emanating from the sample container. The second fiber optic cable or emission detector may include one or more filters that remove scattered excitation light.

According to another aspect of the present invention, a system for detection of induced light emission in a sample is provided. The system typically includes a sample container, an emission detector, and an excitation source configured to generate excitation light having a plurality of different discrete wavelengths. The sample container is positioned to receive excitation light directly from the excitation source, and the emission detector is positioned to receive emission light directly from the excited sample. In operation, the laser or multi-plex lasers provide excitation light to the sample container and the detector directly receives the emission light from the sample container. The emission detector may include one or more filters that remove scattered excitation light. Such a direct optical detection and analysis system advantageously does not require fiber optic cables. In certain aspects, however, fiber optic cables configured to deliver the excitation light to the sample container may be used and/or fiber optic cables configured to receive light emanating (e.g., scattered excitation light and emitted fluorescence light) from the sample container may be used.

According to another aspect of the present invention, a system for detection of induced light emission in a sample is provided. The system typically includes a sample container, an emission detector, and an excitation source configured to generate excitation light having a plurality of different discrete wavelengths. The sample container is positioned to receive excitation light directly from the excitation source, and the emission detector is positioned to receive emission light directly from the excited sample. In operation, the laser or multi-plex lasers provide excitation light to the sample container and the detector directly receives the emission light from the sample container. The emission detector may include one or more filters that remove scattered excitation light. The scattered light filters can be multi or single line. Filters to remove the scattered light can be placed in the optical system path, e.g., using a controlled mechanical device such as a servo motor. One advantage of this design is that the emission spectra transmitted to the detector can be controlled allowing for more sample fluorescent information to be gathered. Such an optical detection and analysis system may or may not use fiber optic fibers for the emission optical path and may or may not use fiber optic fibers for the excitation emission optical path.

According to yet another aspect of the present invention, a method is provided for detecting induced light emission in a sample. The method typically includes generating excitation light having a plurality of discrete wavelengths, providing the excitation light to a sample container over a first single light path, and receiving and analyzing emission light emanating from the sample container with an emission detector configured to spatially separate received light into component wavelengths. In certain aspects, ends of the first and second single light paths are coupled together in a single interface proximal the sample container. The emission path may include one or more filters that remove scattered excitation light.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an analytical multi-spectral optical detection system according to an embodiment of the present invention.

FIG. 2 shows an automated fluorescent optical detector according to an embodiment of the present invention.

FIG. 3 shows another embodiment of an automated fluorescent optical detector according to the present invention.

FIG. 4 shows the ability of three laser diodes to excite six of the most commonly available fluorescent dyes that are used for analysis of biological samples.

FIG. 5 compares the number of optical path hardware components needed to process twenty-four samples by two commercial optical designs and the optical detection system of the present invention.

FIG. 6 illustrates examples of prior art systems.

FIG. 7 shows fluorescent analysis data obtained from a prototype optical system according to the present invention.

FIG. 8 shows real-time PCR fluorescent analysis data obtained from a prototype optical system according to the present invention.

FIG. 9 shows further analysis of the quality of the data obtained from the real-time PCR fluorescent analysis data obtained from a prototype optical system according to the present invention.

### DEFINITIONS

As used herein, a “sample container” refers to a container, holder, chamber, vessel or other elements configured to isolate a liquid or solid sample to be investigated in a desired manner. Examples include a covered or uncovered sample well, a platform having one or more wells and/or one or more addressable locations on the surface of the platform, a vial, a tube, a capillary tube, and a flow path (e.g., fluid channel or microchannel). The sample container may contain or isolate any type or types of samples to be analyzed such as a biological sample or chemical sample. Non-limiting examples might include a nucleic acid sample, a protein sample or a carbohydrate sample.

A “light source” or “excitation source” as used herein refers to the source(s) of excitation light provided or delivered to a sample container. A light source may include one or multiple light emitting elements, where each element may emit light at one or multiple discrete wavelengths or over a range of wavelengths. Emitted light may be coherent or incoherent. One example of a coherent light emitting element is a laser diode. Other examples include pumped diode lasers, gas or solid state lasers, excimer lasers, tunable lasers and others as would be apparent to one skilled in the art. A light emitting diode (LED) is another example of a light emitting element. A light source or excitation source may include a single type of light emitting element, such as one or more LEDs or one or more laser diodes. A light source or excitation source may include multiple types of light emitting elements, such as one or more LEDs and one or more laser diodes.

Excitation light including a “plurality of different discrete wavelengths of light” refers to two or more different discrete wavelengths of light in the excitation light. A “discrete wavelength of light” refers to the bandwidth or linewidth of light emitted by a source of light. Typically a laser or other light source will emit at a particular frequency (wavelength) having a Gaussian shaped emission profile. The center frequency (wavelength) of the gaussian profile typically defines the “frequency” of the output, with a bandwidth defined by the Gaussian emission profile. For a laser, a common characteristic defining the bandwidth may be the full width at half maximum (FWHM) of the Gaussian emission profile. For a laser and other light sources, a smaller bandwidth on the order of about ±2 nm is desirable, however, lasers or other light sources with bandwidths of about ±5 nm or even about ±10 nm or ±20 nm may be useful.

As used herein, a “single light path” refers to light having one or multiple wavelength components traveling over the same path. Where fiber optic cable(s) are used, a light path is defined by the fiber optic cable. Where other optical elements are used, or where no optical elements are used, a light path is defined by the propagation of the light along a given direction, e.g., from a light source to a sample, or from a sample to a detector, or from a light source to a detector.

As used herein, “light emanating from a sample container” refers to the scattered excitation light, if any, and light emitting from a sample constrained by the sample container. Light emitting from a sample may include induced light emission such as fluorescence, phosphorescence, luminescence, chemiluminescence and other emissions, e.g., in the 400 nanometer to 1.2 micrometer range, depending on the constituent(s) of the sample constrained or isolated by the sample container. For example, for fluorescence emissions, a sample may contain or be bound to a fluorescent material or probe which absorbs, or is otherwise excited by or activated by, the excitation light and emits at a different wavelength than the excitation wavelength. The wavelength(s) at which a particular material or probe emits is dependent on the constituents of the material or probe.

As used herein, “induced light emission” refers to the emission of electromagnetic radiation induced by an external stimulus that transfers energy to the substance of interest. External stimulus sources include chemical, electrical, physical, magnetic, electromagnetic and enzymatic sources. Emission mechanisms include fluorescence, phosphorescence, luminescence and chemiluminescence.

As used herein, “spatially separate light into component wavelengths” (and similar terms) refers to dispersing light into its component wavelengths. Dispersion of light may be by way of refraction or diffraction. For example, using an element based on the principle of refraction (e.g., Snell's law), for a light beam containing two different specific component wavelengths of light, the two component wavelengths will be refracted by different amounts. At a certain distance away from the refraction element one component wavelength will be spatially separated from the other component wavelength. Examples of useful elements for dispersing light in a spatial manner include prisms (refraction) and diffraction gratings.

### DETAILED DESCRIPTION OF THE INVENTION

The present invention provides systems and methods for measuring multi-spectral signals, and in particular for measuring multi-spectral fluorescent signals from one or multiple solid or liquid samples.

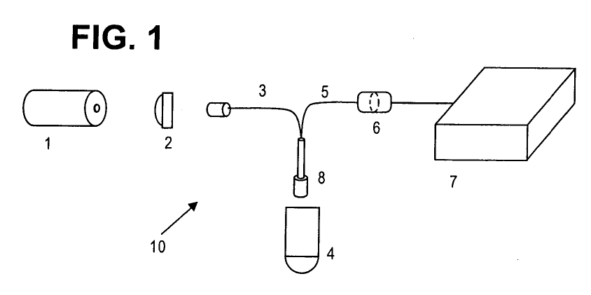

FIG. 1 illustrates an analytical multi-spectral optical detection system 10 according to an embodiment of the present invention. As shown in FIG. 1, laser light from source 1 is coupled into a fiber optic cable 3 and delivered to the sample container 4, e.g., for fluorescence excitation. The emission light from the sample is then collected by the same fiber optic cable interface 8. The emission light is then filtered to remove scattered laser light, using a filter or series of filters, and transferred to a spectrophotometer 7 or other light detection system where the emission light is spatially separated into its component spectra. Detection is accomplished spatially with a linear diode array, charge-coupled device (CCD) or light sensitive device and analyzed, e.g., with function based algorithms.

The excitation light beam from the integrated laser module, in certain aspects, is coupled into excitation fiber optic cable 3, which transmits the light to a vessel 4 containing a liquid or solid phase sample. An optional aspheric lens 2 may be used to focus excitation light into the fiber optic cable 3. The generation of excitation light from the integrated laser system may be controlled, for example, using TTL modulation. This allows the laser lifetime to be extended by only powering the laser during signal acquisition. TTL modulation also allows more control over which dyes are excited to improve the signal to noise ratio of the emission light if needed.

Excitation light can be generated by one or more solid state laser diodes and/or pumped laser diodes that are integrated into a single light source 1. In certain aspects, 2, 3, 4, 5 or more discrete wavelengths of light are generated by source 1, for example, using 2, 3, 4, 5 or more laser diodes. Alternately, or additionally, a single beam multi-line laser may be used that combines multiple laser beams with a block prism or similar beam combining optical component. It should be appreciated that any number of different wavelengths in the visible spectrum may be used, such as for example, about 470 nm, about 530 nm, about 590 nm, about 630 nm, and/or about 685 nm, and combinations thereof. In one specific example, a single excitation light beam is generated that contains one or more laser lines with specific discrete wavelengths of light such as 473 nm±2 nm, 532 nm±2 nm and 633±2 nm.

Light sources can include any type of laser, but a laser diode(s) is the preferred technology. Power can range from about 500 microwatt to about 100 milliwatts, depending on the following requirements: dye photo bleaching rates, limit of detection, sample volume, sample geometry and number of samples per light source. Laser wavelengths from about 400 nm to about 1200 nm can be used depending on the dye specifications. Narrow band lasers are preferred to increase the emission spectra available for analysis, except in cases where a single broad wavelength laser can be used to excite multiple dyes that have similar excitation spectra.

The multi-spectral excitation light is directed (e.g., through air) to the vessel 4 with or without the use of a focusing lens. The use of small fiber optic cables, e.g., about 50 microns to about 200 microns outer diameter, helps to focus the excitation light onto the sample. Light emanating from the illuminated sample 4 is then collected with one or more emission fiber optic cables 5. Emanating light typically includes fluorescent emission light from the sample 4 and scattered excitation light. In one aspect, fiber optic cables 5 are bundled with, or otherwise arranged proximal to, the excitation fiber optic cables 3 in a sample interface 8. Bundling of the emission and excitation fiber optic cables allows for a single fiber optic cable and sample interface, thereby reducing design complexity.

The light collected by fiber cables 5 is transmitted to a spectrophotometer 7 where the light from the sample 4 is separated into its component wavelengths, e.g., with a diffraction grating and detected spatially, e.g., with a CCD. It should be appreciated that other detector components may be used. For example, a prism or other optical element with appropriate dispersion characteristics to spatially separate wavelengths in the collected light may be used in lieu of a diffraction grating, and a diffraction grating may be etched on a window, a lens or a mirror. Additionally, the detector may include a linear diode array, a photomultiplier array, a charge coupled device (CCD) chip or camera or a photo diode array. In certain aspects, the detector has a spectral resolution of about 3 nm or better, although detectors with resolutions of greater than 3 nm may be used. For example, a diffraction gradient spectrophotometer should resolve spectra to at least a 3 nanometer resolution for optimal emission analysis. Larger wavelength resolutions could be used for certain applications that use fewer dyes. A 600 line/mm grating spacing optimizes the grating transmission while providing a 3 nanometer emission resolution. Spacing from 300 lines/mm to 2,400 lines/mm can be used depending on the application. Other types of optical designs such as a prism or gratings cut or etched into other optical components such as lenses can be used in this system. The system is also not limited to Czerny Turner designs, as holographic lens and other folded optic designs can be used. In certain aspects, a useful requirement of the optical system is that the emission light be separated into its component colors with each being detectable to a resolution of less than about 30 nanometers.

In other aspects, the emission cable 5 incorporates a filter element, such as one or more multi-notch laser line filters 6, that removes scattered excitation light from the collected light signal. This prevents saturation of the diffraction grating in the spectrophotometer 7 allowing for analysis of a more complete emission spectra. Although multiple sequential laser line blocking filters can be used, it is preferred that a single filter that blocks one or several specific laser lines be used. This maximizes the emission transmission and simplifies the optical system design. Multiple single line filters are preferred for applications requiring a larger emission spectral range for correct analysis. Laser line filters should block only the excitation light and allow as much sample emission light to pass as possible, in order to optimize the limit of detection of the optical system. Currently Semrock (Rochester, N.Y., USA) manufacture filters that simultaneously block up to three unique laser lines (see example below).

Collected data is then processed to provide quantitative analysis of the fluorescent compounds in the sample.

This design advantageously uses the spectral purity of laser light to eliminate the need for excitation filters as are required in many prior systems. This combined with the replacement of multiple emission filters with a diffraction grating greatly reduces the number of hardware components, interfaces and moving parts.

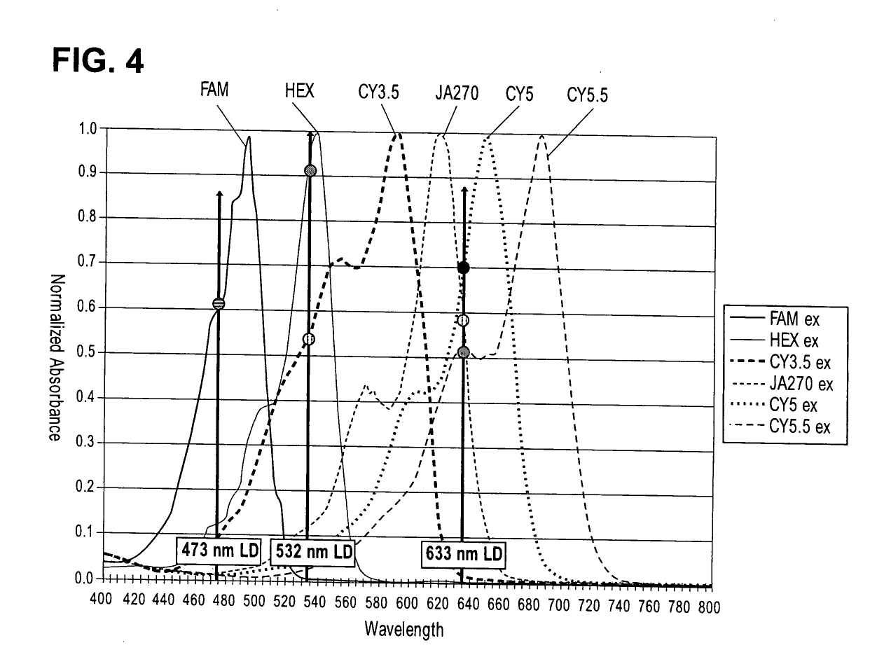

In certain aspects, an optical system of the present invention employs multiple integrated laser diodes with each generating a unique spectral excitation laser line. An example is shown in FIG. 4. In this example, fluorescent dyes with excitation spectra in the 450 to 650 nanometer region are detected. Two additional laser diodes at about 560 and about 670 nanometer may be included to make the coverage of the visible light excitation spectrum more comprehensive. Benefits include a longer product life cycle and a larger potential sample test menu. Another advantage is that a user can choose a single light source (e.g., a single discrete wavelength of excitation light) allowing for single dye detection with increased sensitivity if desired.

The ability to excite multiple dyes with a single light source is another advantage. Several dyes can be detecting simultaneously allowing for faster acquisition times. This is critical for integration into random access detection systems that require fast independent sample detection to meet sample throughput needs.

Simultaneous excitation with a single light path also provides further increases in fluorescent detection precision as compared to prior systems. All of the dyes in all of the samples experience the same transmission variations associated with the detection optics. This eliminates signal variations introduced by multiple optical paths and timing variations. Simultaneous excitation of several dyes also reduces capital manufacturing costs allowing for less expensive products with increased capabilities.

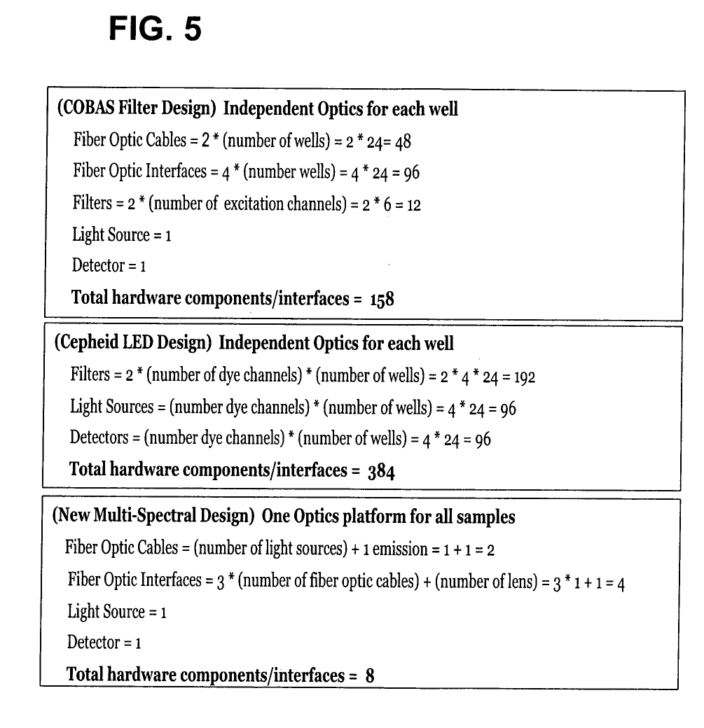

The use of a plurality of fiber optic cables and/or independent optical systems for each sample not only lowers detection precision but also increases manufacturing and service issues. The present invention advantageously minimizes or eliminates many of these components and interfaces providing a more robust design (See, e.g., FIG. 5). The present invention also provides the ability to perform simple calibrations to compensate for hardware variations.

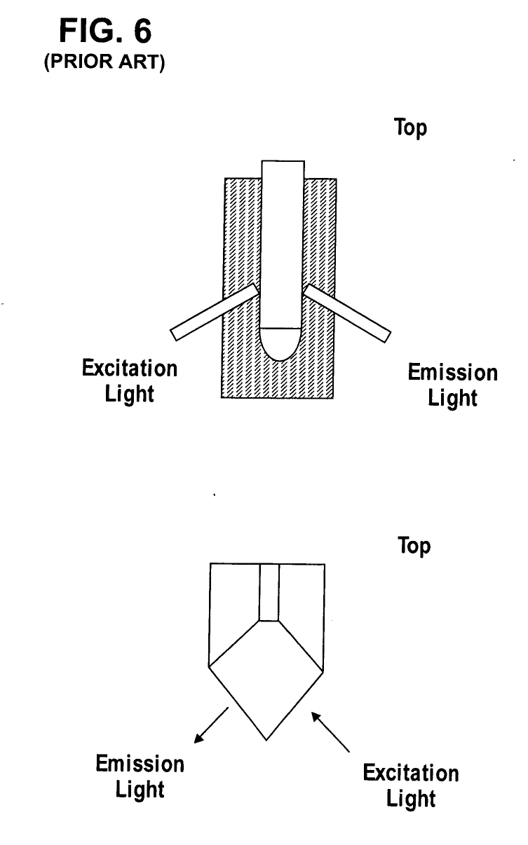

Improvements to robustness are achieved by keeping the optics outside of the sample container well. The outside of sample tubes routinely become contaminated with salt and other substances during pre-detection processing. Prior art systems with optical paths inside the sample holder can become blocked or occluded reducing the precision of the degraded fluorescent signal (See, e.g., FIG. 6).

Coupling the output of multiple laser diodes to a spectrophotometer detection system provides many advantages over conventional light emitting diode designs. First, the higher power and increased fiber optic coupling abilities of the laser diodes provides for a more sensitive and stable detection system. Second, filters that narrow the spectral bandwidth of light from light sources such as light emitting diodes are not required. The system of the present invention is also able to monitor reactions at earlier reaction times allowing low level signals to be discerned with higher confidence.

The collection of the entire emission spectrum in the present invention also allows for real-time correction of spectral abnormalities. This is not possible with filter-based approaches due to the limited information that is collected during detection. The present invention can also distinguish between the probes and other light generating sources providing for even higher reliability.

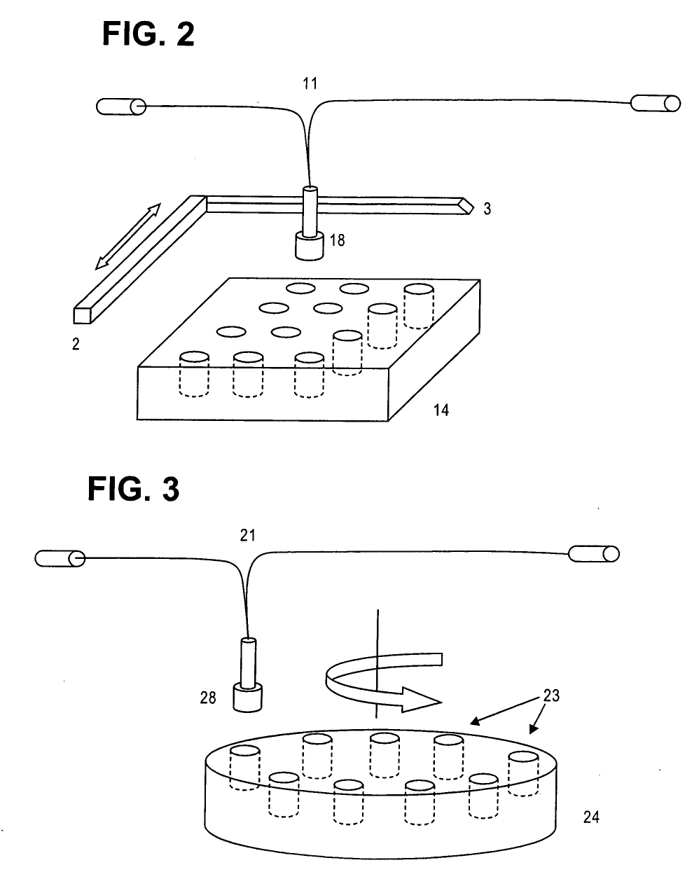

FIG. 2 shows an automated fluorescent optical detector system 11 according to one embodiment. The sample interface 18 portion of the bundled fiber optic cable is attached, or coupled, to an X-Y robotic arm for two dimensional translation of interface 18 along directions 2 and 3 relative to the sample holding platform 14. This allows the optical system to automatically scan multiple sample vessels in platform 18. It should be appreciated that one or three dimensional movement of the fiber optic interface may be effected using other translation mechanisms, such as an X robotic arm or an X-Y-Z robotic arm.

In one aspect, the detector probe 18 is moved continuously in one axis while acquiring signals in time intervals, such as 100 milliseconds. In general, time intervals for acquiring signals can range from about 10 milliseconds to about 500 milliseconds. By synchronizing the axis scan speed with signal acquisition time, multiple readings from each sample vessel can be obtained. Custom algorithms can then identify the best signal from each tube for further signal processing. In one embodiment, an algorithm based on a interpolated cubic spline function constructed for each pure dye spectra is used. Dye mixture spectra are then analyzed with a non-linear regression to find multipliers for cubic spline or similar functions using a Levenberg-Marquardt algorithm. This produces coefficients for each dye that are related to, or otherwise indicative of, the dye concentration.

Use of a single light path for the excitation light and for the collected light advantageously reduces intra-instrument component variations as compared to filter-based designs.

FIG. 3 shows another embodiment of an automated fluorescent optical detector system 21 according to the present invention. In this embodiment, the sample vessels are rotated on a carousel 24 proximal to, e.g., underneath, a fixed detector probe/interface 28. This design provides advantages such as easier sample vessel transfer into the detector module and a reduction of stress induced degradation of the optical fibers.

In certain aspects, the probe interface end holding the optical fiber ends proximal to the sample may be positioned above the sample, below the sample or at the side of a sample. Additionally, the sample container may comprise a flow path (e.g., fluid channel or microchannel), in which case the sample interface probe may be positioned substantially parallel to the flow path. For example, a typical optically uncorrected laser diode produces an elliptical beam that is two millimeters by six millimeters. This size and shape is ideal for processing chambers in micro-fluidic devices. For example, thermal modeling has shown that a two millimeter thickness provides optimal heating for certain microfluidic systems for fast real-time PCR analysis. An inexpensive laser could illuminate the entire chamber without the use of complex optics. Illuminating the entire chamber is important when one considers the fluid dynamics associated with single copy target detection.

FIG. 4 shows the ability of three laser diodes to excite six of the most commonly available fluorescent dyes that are used for analysis of biological samples. Notice that the 633 nanometer laser diode (633 nm LD) excites JA270, CY5 and CY5.5 dyes with a 50 to 70% efficiency. Only three laser diodes are needed to excite these six dyes.

Most commercially available filter-based optical systems suffer from the inability to quantitatively detect more than five visible dyes. This is due to the fact that each dye requires specific light spectrum filters since the emission spectra of one dye overlaps the excitation of another dye. The collection of the entire spectrum of dyes excited by multiple laser diodes allows the quantitative detection of all visible dyes within the wavelength detection range of the spectrophotometer.

It should be noted that dyes with overlapping color can not be distinguished with a filter-based system. These dyes can be distinguished by the current invention allowing for even more visible spectrum dyes to used. For example, two blue dyes with an 80% overlap in spectrum would produce a difference in signal intensity detectable only by filter-based analysis. There is not enough information to differentiate the dyes. A spectrophotometer with about a 3 nanometer resolution could distinguish differences in the spectra and identify each dye with an algorithm.

In addition to the dyes discussed in FIG. 4, it should be appreciated that any fluorescent dye or material may be analyzed that has excitation and emission wavelengths that are within the specifications of the optical system. For example, samples comprising any fluorescent material may be used; a sample may include a fluorescent substance, multiple fluorescent substances, one or more unbound fluorescent probes, one or more fluorescent probes bound to an analyte, etc. Similarly, samples comprising phosphorescent probe(s) or material(s) may be detected and quantified. An example of phosphorescent materials includes Luxcel Bioscience's long-decay Pt(II)- and Pd(II)-coproporphryrin phosphorescent labels. The sample container may include a sample reactor, a flow-through container or a flow-through reactor.

In certain embodiments, fluorescent substances, materials or probes can be selected from the group consisting of fluorescein-family dyes, polyhalofluorescein-family dyes, hexachlorofluorescein-family dyes, coumarin-family dyes, rhodamine-family dyes, cyanine-family dyes, oxazine-family dyes, thiazine-family dyes, squaraine-family dyes, chelated lanthanide-family dyes, BODIPY®-family dyes, and non-fluorescent quencher moieties. Non-fluorescent quencher moieties are substances that reduce, eliminate or control background light emission to enhance detection capabilities. They are typically used in TaqMan probes to reduce or eliminate background emission fluorescence prior to cleavage of the probe oligonucleotide. In certain embodiments, non-fluorescent quencher moieties can include BHQ™-family dyes or Iowa Black™ (Integrated DNA Technologies, Inc.). Other examples of useful dyes include, for example, but not by way of limitation, TAMRA (N,N,N′,N′-tetramethyl-6-carboxyrhodamine) (Molecular Probes, Inc.), DABCYL (4-(4′-dimethylaminophenylazo)benzoic acid) (Integrated DNA Technologies, Inc.), Cy3™ (Integrated DNA Technologies, Inc.) or Cy5™ (Integrated DNA Technologies, Inc.). Other examples of useful materials, probes and substances can be found in U.S. Pat. Nos. 6,399,392, 6,348,596, 6,080,068, and 5,707,813, each of which is hereby incorporated by reference in its entirety.

FIG. 5 compares the number of optical path hardware components needed to process twenty-four samples by two commercial prior art systems and an embodiment of the optical detection system of the present invention. The design of the present invention is vastly simplified by a factor of 20- to 50-fold as compared to the other prior art designs. The main reduction of components results from the removal of optical filters due to the spectral purity of the laser light and the analysis of a larger spectral data set acquired by the spectrophotometer.

The optical detection system of the present invention also examines each sample with the same optical hardware. This reduces sample-to-sample signal variations resulting in higher signal precision than that of systems containing large numbers of interfaces and hardware components. Limiting the number of hardware components and interfaces also reduces manufacturing costs, servicing costs, servicing complexity and costs associated with quality control issues.

In addition to these advantages, systems according to the present invention are more scalable than filter-based designs as more dyes and samples can be accommodated without increasing the number of interfaces or detection times. The number of samples is only limited by data acquisition timing.

### EXAMPLE

Fluorescent analysis data obtained from a prototype optical system according to the present invention.

System Components Include:

Light Source

| | | Part | Center | | Temperature | RMS | Power | Laser |
|---|---|---|---|---|---|---|---|---|
| Description | Vendor | number | Wavelength | Power | Control | Noise | Stability | Class |
| Diode | CNI | MBL-II | 473 nm | 10 mW | Thermoelectric | <30% | <3% | Class IIIb |
| Pumped | Optoelectronics | | | | | | | |
| Laser | Tech. Co., Ltd, | | | | | | | |
| | Changchun, China | | | | | | | |
| Diode | World Star Tech, | TECGL- | 532 nm | 10 mW | Thermoelectric | <0.5% | <0.5% | Class IIIb |
| Pumped | Toronto, ON, | 10 | | | | | | |
| Laser | Canada | | | | | | | |
| Diode Laser | World Star Tech | TECRL- | 635 nm | 10 mW | Thermoelectric | <0.2% | <0.2% | Class IIIb |
| | | 10G-635 | | | | | | |

Detector Optics

| | | | | Laser Line | |
|---|---|---|---|---|---|
| Description | Vendor | Part number | Center Wavelength | Blocking | Transmission |
| Triple Notch | Semrock, | NF01-488/532/635-8-D | 488 nm, 532 nm | 8 O.D. | >95% |
| Laser Line Filter | Rochester | | 633 nm | | |
| | NY | | | | |

Detector

| | | | | | Grating | | |
|---|---|---|---|---|---|---|---|
| | | Part | | | Groove | | |
| Description | Vendor | number | Optical Design | Detector | Density | Slit Width | Special |
| Diffraction | Ocean | HR2000 | Czerny-Turner | Sony ILX511 | 600 lines | 200 um | Silver |
| Gradient | Optics, | | | 2048-element | per inch | | Coated |
| Spectrophoto | Dunedin | | | linear CCD | | | Mirrors |
| meter | FL | | | array | | | |

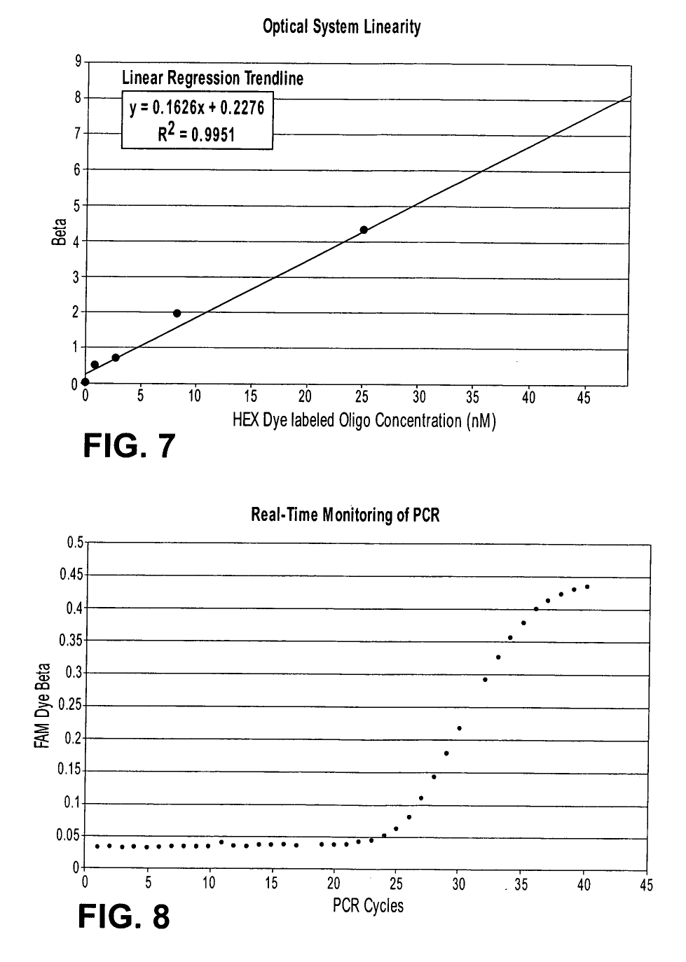

FIG. 7 shows fluorescent analysis data obtained from a prototype optical system according to the present invention. The optical system linearity was tested using a HEX dye probe that was titrated from 50 nanomolar to 0.09 nanomolar. A 532 nanometer laser was used as a excitation light source and the data was analyzed by calculating a beta function based on a regression fit of a model cubic spline function. The optical system linearity is shown by the linear regression fit of the data shown in the top of the figure.

FIG. 8 shows fluorescent analysis data obtained from a prototype optical system, according to the present invention, that monitored a polymerase chain reaction that contained fluorescent analysis probes. The PCR reagent detects Hepatitis C virus and contains two probes: an internal control labeled with HEX dye and a target-specific probe labeled with FAM dye. Both the internal control and target were amplified so that a FAM and HEX signal were generated to simulate a typical HCV diagnostic test signal. A 473 nanometer laser was used as the excitation light source and the data was analyzed by calculating a FAM beta function based on a regression fit of a model cubic spline function. The expected PCR growth curve is shown.

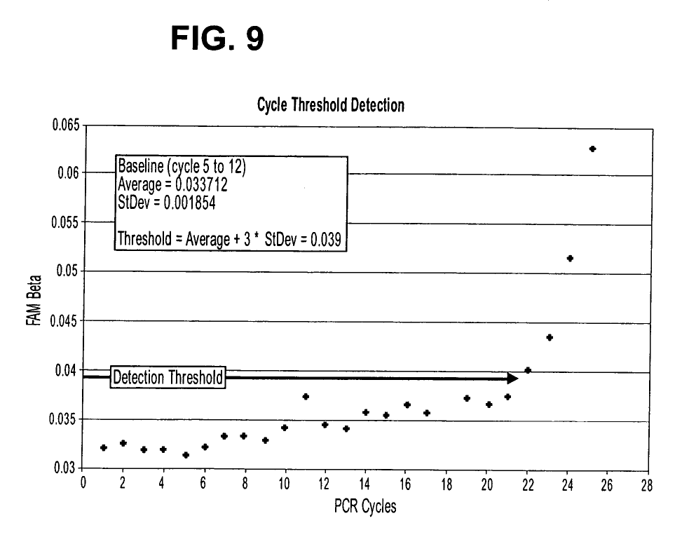

FIG. 9 shows the analysis of the data shown in FIG. 8. In this example, PCR reactions were monitored for signals that are three standard deviations above the baseline noise. The analysis shown in FIG. 9 demonstrates that the initial exponential increase in FAM dye signal was correctly detected at cycle 22. This demonstrates that the prototype system is able to detect real-time PCR signals in a multi-dye background using standard commercial conditions.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, probes and substances may be sequentially or simultaneously excited and sequentially or simultaneously analyzed. Therefore, the scope of the appended claims should be accorded the broadest interpretation so as to encompass all such modifications and similar arrangements.

1. An apparatus for detection of induced light emission in a sample, the apparatus comprising:
(a) a sample container;
(b) a light source configured to provide excitation light to the sample container, said excitation light including a plurality of different discrete wavelengths of light; and
(c) an emission detector configured to receive and spatially separate light emanating from the sample container into component wavelengths.

2. The apparatus of claim 1, wherein the light source comprises at least three laser diodes.

3. The apparatus of claim 1, wherein the light source includes a fiber optic cable effective to transmit the excitation light to the sample container.

4. The apparatus of claim 1, wherein the detector includes a fiber optic cable effective to receive the light emanating from the sample container.

5. The apparatus of claim 1, wherein the light source includes a single beam multi-line laser.

6. The apparatus of claim 1, wherein the light source comprises a first laser diode that generates light having a wavelength of about 470 nm, a second laser diode that generates light having a wavelength of about 530 nm, and third laser diode that generates light having a wavelength of about 630 nm.

7. The apparatus of claim 6, wherein the light source further comprises a fourth laser diode that generates light having a wavelength of about 685 nm.

8. The apparatus of claim 7, wherein the light source further comprises a fifth laser diode that generates light having a wavelength of about 590 nm.

9. The apparatus of claim 1, wherein the light source includes a first fiber optic cable effective to transmit the excitation light to the sample container, and wherein the detector includes a second fiber optic cable effective to receive the light emanating from the sample container.

10. The apparatus of claim 1, wherein the sample container includes one of a sample reactor, a flow through container or a flow through reactor.

11. The apparatus of claim 9, further comprising a plurality of sample containers.

12. The apparatus of claim 11, wherein the sample containers are positioned on an automated carousel.

13. The apparatus of claim 11, wherein the first and second fiber optic cables are attached to one of an X robotic arm, an X-Y robotic arm or an X-Y-Z robotic arm.

14. The apparatus of claim 1, wherein the emission detector comprises a spectrophotometer.

15. The apparatus of claim 1, wherein the emission detector comprises one or more single line filters and/or one or more multi-notch line filters for reducing or removing scattered excitation laser light from the received light.

16. The apparatus of claim 1, further comprising means to control the temperature of the sample container.

17. The apparatus of claim 1, wherein the sample container comprises one of a nucleic acid sample, a protein sample or a carbohydrate sample.

18. The apparatus of claim 9, wherein ends of the first and second fiber optic cables are bundled together to form a single sample interface.

19. The apparatus of claim 18, wherein the sample interface is positioned above the sample container.

20. The apparatus of claim 18, wherein the sample interface is positioned proximal to a side of the sample container.

21. The apparatus of claim 18, wherein the sample container includes a sample flow path and wherein the sample interface is positioned substantially parallel to the flow path.

22. The apparatus of claim 1, wherein the sample container comprises a fluorescent or phosphorescent probe that is not bound to a sample.

23. The apparatus of claim 1, wherein the sample container comprises a fluorescent or phosphorescent probe bound to a sample.

24. The apparatus of claim 1, wherein the sample container comprises a fluorescent or phosphorescent substance.

25. The apparatus of claim 1, wherein the sample container comprises multiple fluorescent and/or phosphorescent probes.

26. The method of claim 25, wherein each of the multiple probes has a different emission wavelength.

27. The apparatus of claim 1, wherein the sample container comprises multiple fluorescent and/or phosphorescent substances.

28. A system for detection of induced light emission in a sample, the system comprising:
(a) a sample container;
(b) an emission detector configured to spatially separate received light into component wavelengths;
(c) an excitation source configured to generate excitation light having a plurality of different discrete wavelengths;
(d) a first fiber optic cable having a first input end and a first output end, wherein the first input end is positioned to receive the excitation light from the excitation source;
(e) a second fiber optic cable having a second input end and a second output end, wherein the second output end is positioned to provide light emanating from the sample container to the emission detector;
(f) a cable interface configured to hold the first output end and the second input end together proximal to the sample container, wherein the first output end provides the excitation light to the sample container and wherein the second input end receives light emanating from the sample container; and
(g) a light filter to remove scattered excitation light from the light emanating from the sample container.

29-32. (canceled)

33. A method of detecting induced light emission in a sample, the method comprising:
generating excitation light having a plurality of discrete wavelengths;
providing the excitation light to a sample container over a first single light path;
receiving and analyzing light emanating from the sample container with an emission detector configured to spatially separate received light into component wavelengths.

34-41. (canceled)

42. The apparatus of claim 1, wherein the emission detector includes a light sensitive detector that cannot distinguish between wavelengths.

43-45. (canceled)

46. The apparatus of claim 1, wherein the emission detector includes one of a prism or a diffraction grating.

47. The apparatus of claim 1, wherein the emission detector includes one of a CCD device, a linear diode array, a photo diode array or a photomultiplier array.

48. The apparatus of claim 1, wherein the light source includes one or more LED elements and/or one or more laser diode elements, each element generating light of a different discrete wavelength.

49. The apparatus of claim 1, wherein the light emanating from the sample container includes induced light emission selected from the group consisting of a fluorescent emission, a luminescent emission, a chemi-luminescent emission, and a phosphorescent emission.

50-51. (canceled)
